(19) United States
(12) Patent Application Publication
(10) Pub. No.: US 2022/0307454 A1
(43) Pub. Date: Sep. 29, 2022

(54) Fitting for a Fluid Delivery System

(71) Applicant: Robert Bosch GmbH, Stuttgart (DE)

(72) Inventors: Luis Humberto Guzman Trevino, Tampico (MX); Cesar Omar Medina Juarez, San Luis Potosi (MX); Hector Hugo Segura Jurado, San Luis Potosi (MX); John Casari, Manchester, MI (US)

(21) Appl. No.: 17/213,972

(22) Filed: Mar. 26, 2021

(51) Int. Cl. F02M 55/00; F02M 55/02

(52) U.S. Cl. CPC F02M 55/005; F02M 55/025; F02M 2200/8084; F02M 2200/803

(57) ABSTRACT

A fuel delivery system includes a connection assembly that reliably connects a high pressure fuel supply line to an inlet of a fuel rail. The connection assembly includes a fitting that decouples the retention function of the connection from the sealing function of the connection. The fitting is hollow and has a spherical leading end that is compressed against an inner conical surface of the fuel rail inlet to an extent that fuel rail material is displaced by the spherical leading end and a fluid-tight first seal is realized between the fitting and the conical surface of the fuel rail inlet. A weld is provided at a location spaced apart from the seal, the weld joining the fitting to the fuel rail inlet and retaining the fitting within the inlet in a compressed state, whereby the first seal is maintained.

### BACKGROUND

A fuel delivery system may include a fuel rail, and multiple fuel injectors that are supplied with fuel by the fuel rail and inject fuel into the intake manifold or cylinders of an internal combustion engine. The fuel rail is supplied with fuel by a fuel supply line that is connected to an inlet of the fuel rail. In some applications, the fuel rail may supply high-pressure fuel through the fuel injectors by directly injecting into corresponding engine cylinders.

Although plastic fuel rails are known, metal fuel rails may be used to deliver fuel at high pressure, and include a main fuel supply pipe referred to as a “log”. As used herein, the term “high pressure” refers to pressures greater than 250 bar. The log has a main fuel channel through which fuel is supplied from a fuel tank or fuel pump. The fuel rail includes an integral inlet that connects the fuel rail to the fuel line. The connection of the inlet to the fuel line is a critical joint in high pressure fuel systems. Some conventional fuel delivery systems employ connections in which the fuel line retention features are coupled with sealing features using highly variable processes that are difficult to control. In addition, some conventional fuel delivery systems employ fuel line-to-fuel rail inlet connections having shapes and materials that require high precision in manufacture and assembly, which result in increased manufacturing complexity and cost. It is desirable to provide a connection between a high pressure fuel line and an inlet of a fuel rail in which retention features are de-coupled from the sealing features, and which have few parts and are relatively simple to manufacture.

### SUMMARY

A fuel delivery system including a connection between the fuel supply line and the fuel rail inlet that is achieved using an inlet fitting that decouples the retention function of the connection from the sealing function of the connection. The inlet fitting has a spherical leading end that is compressed against an inner conical surface of the fuel rail inlet to an extent that fuel rail material is displaced by the spherical leading end and a fluid-tight first seal is realized between the inlet fitting and the conical surface of the fuel rail inlet. A weld is provided at a location spaced apart from the seal, the weld joining the inlet fitting to the fuel rail inlet and retaining the inlet fitting within the inlet in a compressed state, whereby the first seal is maintained. In some embodiments, the weld can extend along a line that extends 360 degrees along the circumference to form a fluid-tight second seal between the inlet fitting and the fuel rail inlet that is functionally decoupled from the failure modes of the first seal. The trailing end of the inlet fitting is configured to be connected to the fuel supply line via a connector that provides a fluid-tight third seal. The inlet fitting includes a fitting through passage that extends between the leading end and the trailing end, allowing fuel to be delivered from the fuel supply line to the main fuel channel of the fuel rail.

In some aspects, a fitting connects a fluid line to an inlet of a fluid-receiving structure. The fitting includes a leading end configured to be inserted into the inlet of a fluid-receiving structure. The leading end has profile in the shape of a truncated curve when the fitting is viewed in side view. The fitting includes a trailing end opposed to the leading end. The trailing end is cylindrical and includes an external thread that is configured to engage an internal thread of the fluid line. In addition, the fitting includes an intermediate portion disposed between the leading end and the trailing end, a fitting longitudinal axis that extends between the leading end and the trailing end and a fitting through passage that is co-linear with the fitting longitudinal axis and extends between the leading end and the trailing end.

In some embodiments, the fitting comprises a cavity disposed at an intersection of the through passage with the trailing end, a surface of the cavity having a conical profile when viewed in cross section.

In some embodiments, the fitting is metal and is fanned in a cold forging process.

In some embodiments, the intermediate portion is cylindrical and an outer surface of the intermediate portion is free of an external thread.

In some embodiments, the external thread is shaped and dimensioned to engage with an internal thread of a gland nut of the fluid line.

In some embodiments, the fitting through passage includes a reduced diameter portion that is configured to dampen pulsation of fluid passing through the through passage.

In some aspects, a connection assembly for connecting a fluid line to an inlet of a fluid-receiving structure includes the inlet. The inlet includes an inlet passageway that permits communication between the environment and an interior space of the fluid-receiving structure. The connection assembly includes a fitting disposed between, and forming a connection between, the fluid line and the inlet. The fitting includes a leading end disposed in the inlet, and a trailing end opposed to the leading end. The leading end has profile in the shape of a truncated curve when the fitting is viewed in side view. The trailing end is disposed outside the inlet, the trailing end being cylindrical and including an external thread that is configured to engage an internal thread of the fluid line. The fitting includes an intermediate portion disposed between the leading end and the trailing end, a fitting longitudinal axis that extends between the leading end and the trailing end, and a fitting through passage that is co-linear with the fitting longitudinal axis and extends between the leading end and the trailing end. The connection assembly also includes a first seal disposed between the fitting and the inlet passageway and a weld joint that joins the intermediate portion and the inlet passageway whereby the fitting is retained in the inlet.

In some embodiments, the weld joint extends about a full circumference of the inlet passageway and provides a second seal between the fitting and the inlet passageway.

In some embodiments, the external thread is shaped and dimensioned to engage with an internal thread of a gland nut of the fluid line. In addition, the fitting through passage includes a portion that is configured to form a third seal with a spherical element of the fluid line when the gland nut is engaged with the external threads.

In some embodiments, the inlet passageway includes a passageway cylindrical portion that opens at an open end of the inlet. The passageway cylindrical portion has a passageway diameter that is greater than a diameter of the internal space. In addition, the inlet passageway includes a passageway conical portion that extends between the passageway cylindrical portion and the internal space. A curved portion of the fitting leading end abuts the passageway conical portion in such a way that the first seal is provided between the curved portion and the passageway conical portion.

In some embodiments, the weld joint is disposed between passageway conical portion and an open end of the inlet.

In some embodiments, the inlet includes an inlet longitudinal axis that extends in parallel to the inlet passageway; and a flange that protrudes from an outer surface of the inlet in a radial direction relative to the inlet longitudinal axis.

In some embodiments, the inlet is formed of a first material, the fitting is formed of a second material, and the hardness of the second material is greater than the hardness of the first material.

In some embodiments, the first seal is a metal-to-metal seal in which the fitting deforms a surface of the inlet passageway.

In some embodiments, a curved portion of the fitting leading end abuts the passageway conical portion under a longitudinal applied force in such a way that at least one of the curved portion and the passageway conical portion is deformed, whereby the first seal is provided between the curved portion and the passageway. In addition, the weld joint retains the fitting and passageway under the applied force.

In some aspects, a method of manufacturing a fuel supply system is provided. The fuel system includes a fuel supply line, a fuel rail and a fitting that connects the fuel supply line to an inlet of the fuel rail. The method includes providing the fuel rail. The fuel rail includes a rail log that defines an interior space, and the inlet. The inlet includes an inlet passageway having a conical portion, and the inlet passageway communicates with the interior space. The method includes providing the fitting, where the fitting includes a leading end configured to be received in the inlet passageway, and a trailing end configured to reside outside the inlet and connect to the fuel supply line. The fitting also includes a longitudinal axis that extends between the leading end and the trailing end, and a fitting through passage that is co-linear with the longitudinal axis and extends between the leading end and the trailing end. The method includes inserting the leading end of the fitting into the inlet passageway, and applying a force to the fitting in a direction parallel to the longitudinal axis and toward the interior space of the log. In this step, the force is sufficient to cause the fitting to deform a surface of the inlet passageway and form a first seal between the fitting and the surface of the it passageway. The method includes forming a weld joint between the inlet and the fitting in such a way that the first seal is maintained.

In some embodiments, the method includes providing the fuel supply line, the fuel supply line including a gland nut having an internal thread, a pipe that extends through the gland nut and a spherical gland disposed on a terminal end of the pipe. In addition, the method includes securing the fuel supply line to the fitting trailing end by engaging the internal thread with an external thread of the fitting trailing end.

In some embodiments, the weld joint extends about a full circumference of the fitting and provides a second seal between the fitting and the inlet.

In some embodiments, the fitting is manufactured using a forging process.

In some embodiments, the inlet is formed of a first material, the fitting is formed of a second material, and the hardness of the second material is greater than the hardness of the first material.

### BRIEF DESCRIPTION OF THE FIGURES

FIG. 1 is a schematic view of a fuel delivery system that includes a fuel rail that receives high pressure fuel from a fuel tank via a fuel supply line.

FIG. 2 is a perspective view of a portion of the fuel delivery system of FIG. 1, illustrating the fuel supply line connected to the fuel rail via a connection assembly.

FIG. 3 is a cross-sectional view of the connection assembly as seen along line 3-3 of FIG. 2.

FIG. 4 is a cross-sectional view of the fuel rail inlet, shown in isolation, as seen along line 3-3 of FIG. 2.

FIG. 5 is a front perspective view of an inlet fitting.

FIG. 6 is a rear perspective view of the inlet fitting of FIG. 5.

FIG. 7 is a cross-sectional view of the inlet fitting of FIG. 5 as seen along line 7-7 of FIG. 5.

FIG. 8 is a front perspective view of an alternative embodiment inlet fitting.

FIG. 9 is a rear perspective view of the inlet fitting of FIG. 8.

FIG. 10 is a cross-sectional view of the inlet fitting of FIG. 8 as seen along line 10-10 of FIG. 8.

FIG. 11 is a flow chart illustrating a method of manufacturing the fuel delivery system.

### DETAILED DESCRIPTION

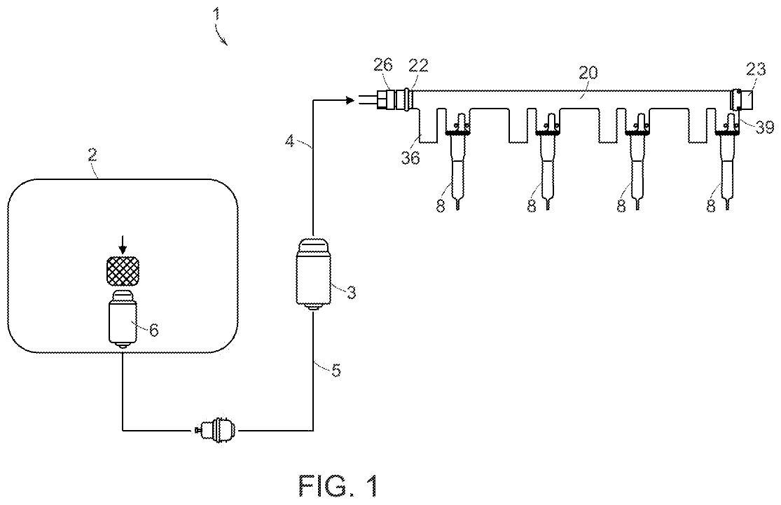

Referring to FIGS. 1-3, a fuel delivery system 1 includes a fuel rail 20 that is configured to supply fuel to multiple fuel injectors 8 that inject fuel directly into the cylinders of an internal combustion engine (not shown). The fuel rail 20 receives high pressure fuel from a high pressure fuel supply line 4. The fuel supply line 4 is connected to a fuel tank 2 via a high pressure fuel pump 3. The high pressure fuel pump 3 is connected via a low pressure line 5 to a low pressure fuel pump 6 (e.g., a “fuel sender”) disposed inside the fuel tank 2. The fuel rail 20 includes an integral inlet 26 that is configured to he connected to the fuel supply line 4. As used herein, the term “integral” is defined as “being of the whole, being formed as a single unit with another part.” In some embodiments, the fuel delivery system 1 is configured to deliver high pressure fuel to the fuel rail 20, which in turn delivers high pressure fuel to the fuel injectors 8. The fuel delivery system 1 includes a connection assembly 60 that provides a fluid-tight mechanical connection between the fuel supply line 4 and the fuel rail inlet 26. In particular, the connection assembly 60 provides a mechanical connection in which features that retain the fuel supply line 4 in the connected configuration with the fuel rail 20 are de-coupled from features that provide a fluid tight seal, as discussed in detail below. In addition, the connection assembly 60 has a relatively few number of pans as compared to some conventional connectors, as discussed in detail below.

The connection assembly 60 includes the fuel rail inlet 26, the fuel supply line 4 and an inlet fitting 40 that connects the fuel supply line 4 to the fuel rail inlet 26. The elements of the connection assembly 60 will now be described in detail.

The fuel supply line 4 is configured to deliver high pressure fuel to the fuel rail 20. The fuel supply line 4 includes a thick-walled metal pipe 10 that terminates in a pipe connector 11. The pipe connector 11 includes a hollow, ball-shaped gland 12 that is fixed to the open end of the pipe 10 in a sealed manner. The open end of the pipe 10 is disposed inside the gland 12, and faces a gland orifice 13. The pipe connector 11 also includes a gland nut 14 having an internal thread 15. The pipe 10 extends through an open first end 16 of the gland nut 14 so that the gland 12 is disposed inside the gland nut 14. The gland orifice 13 faces an open second end 17 of the gland nut 14. Although the pipe 10 is movable relative to the gland nut 14, the gland nut first end 16 is dimensioned to prevent withdrawal of the gland 12, and thus also the pipe 10, from the gland nut first end 16. In this configuration, the gland nut 14 is tightened to a specified torque to draw the gland 12 tightly to the inlet fitting 40.

The fuel rail 20 is configured to provide high-pressure distribution of fuel. The fuel rail 20 includes a log 21 and injector cups 39 that depend integrally from the log 21 via distribution anus (not shown). The fuel rail also includes mounting bosses 36 that receive fasteners (not shown) that secure the fuel rail 20 to the vehicle engine.

The fuel rail 20 includes the log 21, which is an elongate hollow tube that provides a common rail or manifold. In the illustrated embodiment, the log 21 is cylindrical, but is not limited to having a cylindrical shape. The log 21 includes a log first end 22, a log second end 23 that is opposed to the log first end 22, and a fuel rail longitudinal axis 24 that extends between the log first and second ends 22, 23. The log 21 is thick walled to accommodate high fuel pressures, and an inner surface of the log defines the main fuel channel 25 through which fuel is supplied from the fuel tank 2 via the fuel pump 3. The centerline of the main fuel channel 25 coincides with the fuel rail longitudinal axis 24. The log material and dimensions are determined by the requirements of the specific application. For example, in some embodiments, the log 21 is a tube made of stainless steel, having a diameter d1 in the order of 15 mm to 30 mm and haying a wall thickness t1 in the order of 1.5 to 4 mm. In some embodiments, the log 21 may include a boss (not shown) configured to receive a pressure sensor. One end of the log 21, for example the first end 22, is shaped to provide the inlet 26. In the illustrated embodiment, the opposed end of the log 21, for example the second end 23, is closed.

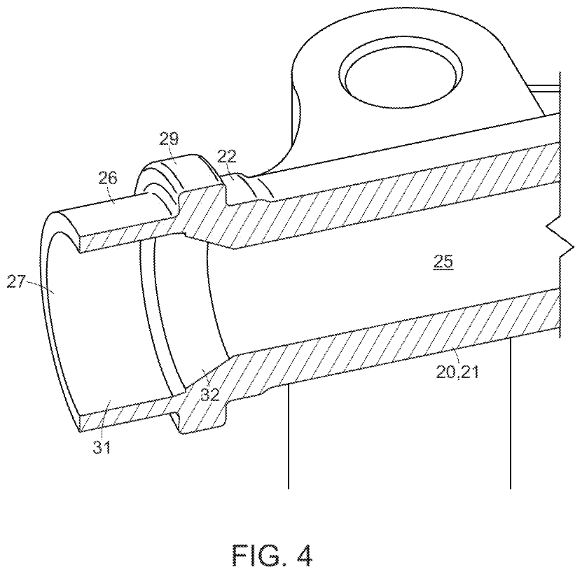

Referring to FIG. 4, the fuel rail inlet 26 protrudes from the log first end 22 in a direction parallel to the fuel rail longitudinal axis 24. The fuel rail inlet 26 is a hollow cylinder having an outer diameter d3 that is slightly greater than the outer diameter d1 of the log 21. In the illustrated embodiment, the fuel rail inlet 26 may include a flange 29 that protrudes in a direction perpendicular to the fuel rail longitudinal axis 24 and extends continuously about the circumference of the fuel rail inlet 26. However, in other embodiments (not shown), the flange 79 may be discontinuous or omitted.

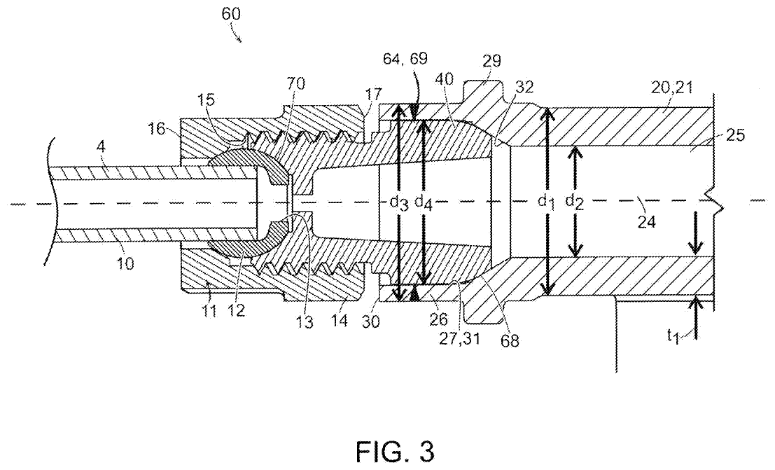

An inner surface of the fuel rail inlet 26 defines an inlet passageway 27 that extends between the inlet outer end 30 and the fuel rail main fuel channel 25. The inlet outer end 30 is open, whereby the inlet passageway 27 permits communication between the main fuel channel 25 and the environment. The inlet passageway 27 includes a cylindrical inner chamber 31 that is coaxial with the inlet outer surface and adjoins, and opens to, the inlet outer end 30. The inner chamber 31 is coaxial with the fuel rail longitudinal axis 24, and has a diameter d4 that is greater than the diameter d2 of the main fuel channel 25. In addition, the inlet passageway 27 includes a conical portion 32 that extends between the inner chamber 31 and the main fuel channel 25. The conical portion 32 tapers so as to have a minimum diameter at the intersection with the main fuel channel 25. In the illustrated embodiment, the conical portion 32 is at an angle of 60 degrees+/−2 degrees relative to the fuel rail longitudinal axis 24, but other angles may be employed as required by the application. The flange 29 is aligned with the conical portion 32 as seen when the fuel rail inlet 26 is viewed in a longitudinal cross section (FIG. 3).

The distribution anus are spaced apart along the length of the log 21 and are configured to distribute pressurized fuel to a respective individual cylinder of the engine. Each distribution arm terminates in an integral injector cup 39, which is configured to receive an inlet end of a fuel injector 8. Each distribution arm includes an internal fuel passageway that provides communication between the main fuel channel 25 and an interior of the respective injector cup 39.

Each injector cup 39 is a cup shapes structure that is disposed at the distal end of a corresponding distribution arm 37. In applications in which the fuel rail 20 is mounted above a cylinder head that is located on top of a block of the engine, the injector cups 39 open downward. An inlet end of the fuel injector 8 may be retained in the injector cup by a retaining device such as a clip or other retention means. The fuel rail 20 and fuel injectors are located relative to the engine so as to provide direct injection of fuel into the engine cylinders.

Thus, fuel is provided at high pressure to each injector cup 39 via the main fuel channel 25 of the log 21 and the fuel passageways 38 of the respective distribution anus 37. High pressure fuel received in the fuel rail 20 is distributed directly into each cylinder of the engine via the fuel injectors 8 connected to the injector cups 39. The number of distribution arms and injector cups 39 that protrude from the log 21 depends on the engine configuration. For example, when a four-cylinder engine is used, the log 21 may be provided with four distribution arms 37 that are spaced apart long the fuel rail longitudinal axis 24, whereas when a straight-six engine is used, the log 21 may be provided with six distribution arms 37 that are spaced apart long the fuel rail longitudinal axis 24. The number of logs 21 can be more than one. For example, in some V-engine configurations V6, V8, V10, and V12, the inlet 40 may be used with additional pipes 10 of the nature of fuel supply line 4 to transfer fuel between the logs 40.

In some embodiments, the fuel rail 20 is a monolithic structure in which the log 21, the distribution arms and the injector cups 39, are formed integrally from a single billet of metal. In some embodiments, the fuel rail 20 including the log 21, the inlet 26, the distribution arms and injector cups 39 are formed integrally of metal in a forging process. In other embodiments, the fuel rail 20 may be machined from a single piece and/or manufactured using other processes such as, but not limited to, extrusion, casting, and injection molding. In still other embodiments, the fuel rail 20 may be formed of multiple pieces joined by brazing, welding or other methods.

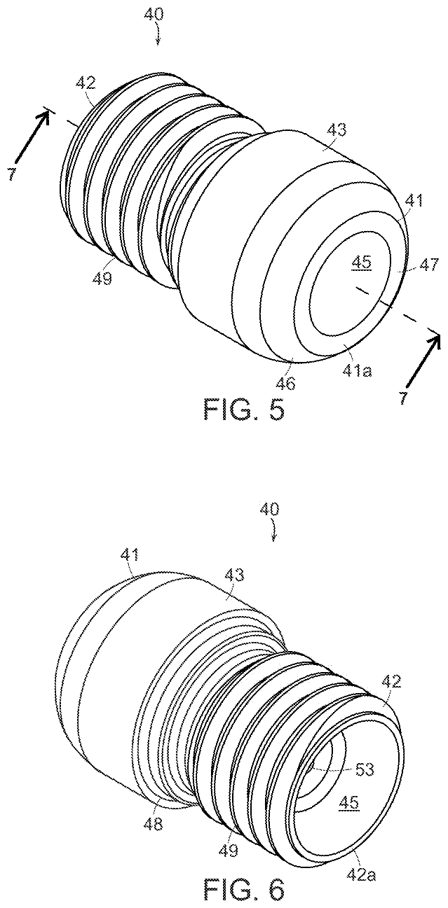

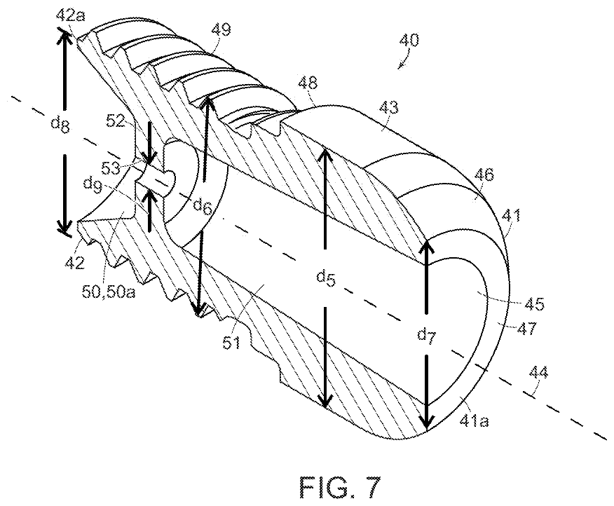

Referring to FIGS. 5-7, the inlet fitting 40 is a metal part that provides a fluid-tight mechanical connection between the fuel supply line 4 and the fuel rail inlet 26. Generally, the inlet fitting 40 is a thick-walled hollow cylinder, and includes a leading end 41 that is configured to be received in the fuel rail inlet 26, a trailing end 42 that is opposed to the leading end 41 and protrudes outside the fuel rail inlet 26, and an intermediate portion 43 disposed between the leading end 41 and the trailing end 42. The leading end 41 and intermediate portion 43 are dimensioned to be inserted into the inner chamber 31 of the fuel rail inlet 26. In addition, the transition between the leading end 41 and intermediate portion 43 is smooth.

The inlet fitting 40 includes a fitting longitudinal axis 44 that extends between the leading end 41 and the trailing end 42, and the inlet fitting 40 is rotationally symmetric about the fitting longitudinal axis 44. In addition, the inlet fitting 40 includes a through passage 45 that coincides with the fitting longitudinal axis 44 and opens at each of the leading and trailing ends 41, 42.

The leading end 41 has curved portion 46 and a truncated portion 47 that together provide the leading end 41 with a profile in the shape of a portion of a truncated sphere when the inlet fitting 40 is viewed in a direction perpendicular to the fitting longitudinal axis 44. The truncated portion 47 defines a planar end face 41a of the leading end 41. The truncated portion 47 is perpendicular to the fitting longitudinal axis 44.

The intermediate portion 43 is disposed between the leading end 41 and the trailing end 42. The intermediate portion 43 is cylindrical and free of an external thread. The outer diameter d5 of the intermediate portion 43 corresponds to, or is slightly less than, the inner diameter d4 the inlet inner chamber 31.

The trailing end 42 adjoins the intermediate portion 43, and is cylindrical. An outer surface of the trailing end 42 includes an external thread 49 that is configured to engage the internal thread of the gland nut 14 of the fuel supply line 4. The outer diameter d6 of the external thread 49 is less than the outer diameter d5 of the intermediate portion, and a shoulder 48 is disposed at the transition between the two outer diameters d5, d6.

In some embodiments, the diameter d7 of the end face 41a of the leading end 41 is set to be the same as the diameter d8 of the end face 42a of the trailing end 42. This configuration allows multiple inlet fittings 40 to be packaged for transportation and/or manufacturing in a sleeve, where the inlet fittings 40 are arranged end-to-end within the sleeve. Since the respective end faces 41a, 42a of each inlet fitting 40 have the same diameter, the inlet fittings 40 do not nest while stacked end-to-end, whereby surface damage to the through passage 45 and curved portion 46 is avoided during shipping and/or assembly. Avoidance of surface damage to the through passage 45 and curved portion 46 allows for reliable fluid sealing of the connection assembly 60.

The fitting through passage 45 extends between the leading end 41 and the trailing end 42 and is co-linear with the fitting longitudinal axis 44. The diameter of the through passage 45 is irregular along the fitting longitudinal axis 44. In particular, the through passage 45 includes an entrance cavity 50 that opens at the thee 42a of the trailing end 42, and an exit cavity 51 that opens at the end face 41a of the leading end 41. The through passage 45 includes a reduced diameter portion 52 that separates the entrance cavity 50 from the exit cavity 51, and defines a cylindrical damping channel 53.

The entrance cavity 50 is disposed between the trailing end end face 42a and the reduced diameter portion 52. The entrance cavity 50 has a conical profile that tapers so as to have a minimum diameter at the intersection with the reduced diameter portion 52. In the illustrated embodiment, the conical surface 50a of the entrance cavity 50 is at an angle of 60 degrees+/−2 degrees relative to the inlet fitting longitudinal axis 44, but other angles may be employed as required by the application. In use, the entrance cavity 50 receives the spherical gland 12 of the fuel supply line 4, and the gland 12 abuts the entrance cavity conical surface 50a. Upon sufficient tightening of the gland nut 14, a fluid tight seal is formed between the gland 12 and the entrance cavity conical surface 50a, whereby fuel delivered through the supply line 4 is directed into the damping channel 53.

The exit cavity 51 is disposed between the reduced diameter portion 52 and the end face 41a of the leading end 41. The exit cavity 51 has a conical profile that tapers so as to have a maximum diameter at the intersection of the exit cavity 51 with the leading end end face 41a. The longitudinal dimension of the exit cavity 51 is at least three times the longitudinal dimension of the entrance cavity 50. In the illustrated embodiment, the longitudinal dimension of the exit cavity 51 is approximately five times the longitudinal dimension of the entrance cavity 50, and is about three-fourths of the overall longitudinal dimension of the inlet fitting 40.

The damping channel 53 is concentric with the fitting longitudinal axis 44, has a longitudinal dimension that is greater than its diameter d9. The damping channel 53 is configured to dampen pulse frequencies of the pressurized fuel passing there through. For example, the diameter d9 and longitudinal dimension of the damping channel 53 may be selected (e.g., tuned) to reduce pulsation frequency of the fuel.

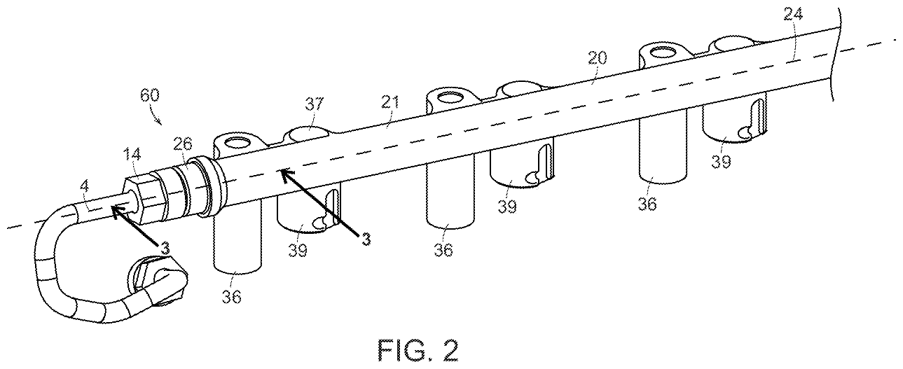

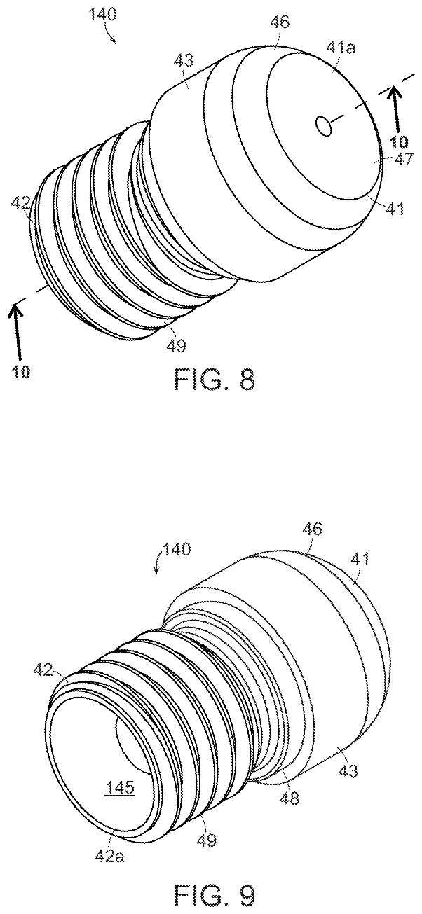

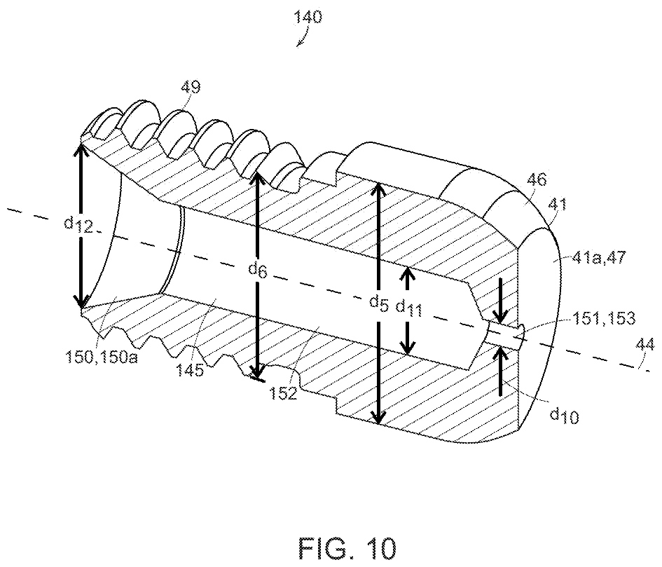

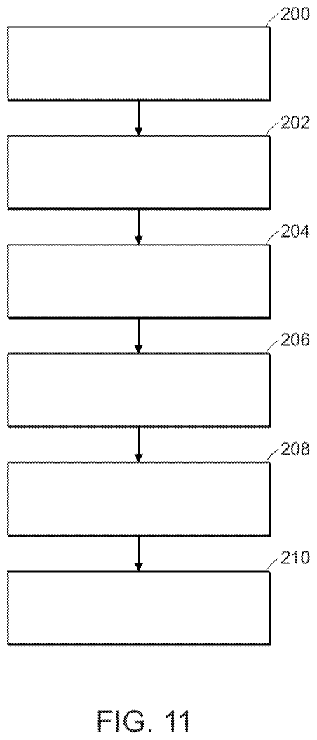

Referring to FIGS. 8-10, an alternative embodiment inlet fitting 140 is a metal part that provides a fluid-tight mechanical connection between the fuel supply line 4 and the fuel rail inlet 26. The inlet fitting 140 shown in FIGS. 8-10 is similar to the inlet fitting 40 illustrated in FIGS. 2 and 5-7, and common elements are referred to with common reference numbers.

The inlet fitting 140 differs from the inlet fitting 40 illustrated in FIGS. 2 and 5-7 with respect to the shape of the through passage 145 and the size of the opening at the end face 41a of the leading end 41.

The diameter of the through passage 145 is irregular along the fitting longitudinal axis 44. In particular, the through passage 145 includes an entrance cavity 150 that opens at the face 42a of the trailing end 42, and an exit cavity 151 that opens at the end face 41a of the leading end 41. In addition, the through passage 145 includes a central cavity 152 that extends between the entrance cavity 150 and the exit cavity 151.

The entrance cavity 150 is disposed between the trailing end end face 42a and the central cavity 152. The entrance cavity 150 has a conical profile that tapers so as to have a minimum diameter at the intersection with the central cavity 152. In the illustrated embodiment, the conical surface 150a of the entrance cavity 150 is at an angle of 60 degrees+/−2 degrees relative to the inlet fitting longitudinal axis 44, but other angles may be employed as required by the application. In use, the entrance cavity 150 receives the spherical gland 12 of the fuel supply line 4. Upon sufficient tightening of the gland nut 14, a fluid tight third seal 70 is formed between the gland 12 and the entrance cavity conical surface 150a, whereby fuel delivered through the supply line 4 is directed into the central cavity 152.

The exit cavity 151 is disposed between the central cavity 152 and the end face 41a of the leading end 41. The exit cavity 151 has a cylindrical profile of small diameter relative to the diameter of the central cavity 152, whereby the exit cavity 151 serves as a damping channel 153 for the inlet fitting 140. The exit cavity 151 is concentric with the fitting longitudinal axis 44, has a longitudinal dimension that is greater than its diameter d10. The exit cavity 151 is configured to dampen pulse frequencies of the pressurized fuel passing there through. For example, the diameter d10 and longitudinal dimension of the exit cavity 151 may be selected (e.g., tuned) to reduce pulsation frequency of the fuel.

The central cavity 152 is disposed between the entrance cavity 150 and the exit cavity 151. The central cavity 152 is cylindrical, free of surface features such as threads and concentric with the fitting longitudinal axis 44. A diameter d11 of the central cavity 152 is greater than the diameter d10 of the exit cavity 58, and a beveled portion 154 provides the transition between, the central cavity 152 and the exit cavity 151. The diameter d11 of the central cavity 152 is less than the maximum diameter d12 of the entrance cavity 150. The longitudinal dimension of the central cavity 152 is about two-thirds of the overall longitudinal dimension of the inlet fitting 140.

In the connection assembly 60, the inlet fitting 40, 141 is partially disposed in the fuel rail inlet 26 such that the fitting leading end 41 is disposed in the inlet passageway 27 with the curved portion 46 abutting the inlet conical portion 32. During assembly, the inlet fitting 40, 140 is inserted into the inlet 26 under an axial force that urges the inlet fitting 40, 140 toward the log 21. The axial force is sufficient to press the curved portion 46 against the conical portion 32 of the inlet passageway 27 to an extent that the conical portion 32 is deformed and a fluid-tight, metal-to-metal first seal 68 is formed between the inlet fitting curved portion 46 and the inlet conical portion 32. This seal, referred to hereafter as “the first seal 68” extends about the entire circumference of the conical portion. In addition, the first seal 68 has a longitudinal dimension (e.g., a “seal zone” or “seal band”) that is greater than a dimension of a line such as might occur along an intersection of an edge with a planar surface. For example, in some embodiments, the longitudinal dimension l1 of the first seal 68 is in a range of 0.75 mm to 1.5 mm.

To ensure that the fuel rail inlet 26 is deformed rather than the inlet fitting 40, 140, the material used to form the inlet fitting 40, 140 is selected to have a greater hardness than the material used to form the fuel rail 20 including the inlet 26. In some embodiments, the inlet fitting 40, 140 is a metal part haying a hardness that is greater than that of the fuel rail inlet 26. When the fuel rail inlet 26 is formed as a single unit with the fuel rail 20, the inlet fitting 40, 140 has a hardness that is greater than that of the fuel rail 20. In some embodiments, the inlet fitting 40, 140 has a hardness that is at least ten percent greater than that of the fuel rail inlet 26. In some embodiments, the inlet fitting 40, 140 has a hardness that is at least fifteen percent greater than that of the fuel rail inlet 26. In some embodiments, the inlet fitting 40, 140 has a hardness that is twenty percent greater than that of the fuel rail inlet 26. In some embodiments, the inlet fitting 40, 140 has a hardness that is in a range of fifteen percent to twenty-five percent greater than that of the fuel rail inlet 26. In some embodiments, the inlet fitting 40, 140 has a hardness that is in a range of ten percent to thirty percent greater than that of the fuel rail inlet 26. As a result, when the first seal 62 is formed between the inlet fitting curved portion 46 and the inlet conical portion 32 by compressing the inlet fitting 40, 141 into the inlet 26 until deformation occurs, the surface of the inlet conical portion is deformed rather than the surface of the inlet fitting 40, 141.

In some embodiments, the inlet fitting 40, 140 is a cold-forged metal part. For example, the inlet fitting 40 described with respect to FIGS. 2 and 5-7 is structurally suited for forming in a cold forging process. In some embodiments, the inlet fitting 40, 140 is a precision machined metal part. For example, the inlet fitting 140 described with respect to FIGS. 8-10 is structurally suited for forming in a precision machining process.

The first seal 68 is maintained by securing the inlet fitting 40, 140 to the fuel rail inlet 26 in the compression-loaded configuration. In this configuration, the inlet fitting trailing end 42 including the external thread 49 protrudes outward from the inlet outer end 30. The inlet fitting 40, 140 is secured and retained in this configuration relative to the fuel rail inlet 26 via a weld joint 64. The weld joint 64 joins the inlet fitting intermediate portion 43 to the fuel rail inlet 26 at a location between the inlet conical portion 32 and the inlet outer end 30. The weld joint 64 extends about a circumference of the inlet fitting 40, 140. In some embodiments, the weld joint 64 is discontinuous along the circumference. In other embodiments, the weld joint 64 extends continuously about the full circumference to form closed ring that provides a fluid-tight second seal 69 between the inlet fitting 40, 140 and the fuel rail inlet 26 (e.g., the inner surface of the inlet passageway 27). The second seal 69 is a redundant seal to the first seal 68, and is decoupled from failure modes of the first seal 68.

In the connection assembly 60, the pipe 10 is secured to the inlet fitting trailing end 42 via the pipe connector 11. In particular, the gland 12 is received in the entrance cavity 50, 150 while the internal thread 15 of the gland nut 14 is engaged with the inlet fitting external thread 49. The gland nut 14 is sufficiently tightened so that the gland 12 abuts, and forms a fluid-tight third seal 70 with the conical surface of the entrance cavity 50, 150. By this configuration, fluid is directed from the pipe 10 into the inlet fitting through passage 45 and then into the fuel rail main fuel channel 25. In some embodiments, the hardness of the inlet fitting is greater than the hardness of the gland 12, whereby the gland 12 may be deformed during formation of the third seal 70.

In the first seal 68, the mating surfaces include the spherical curved portion 46 of the inlet fitting 40, 140 and the conical portion 32 of the inlet passageway 27, which allow for positional tolerance between these elements by reducing sensitivity to size, shape and position of the mating surfaces without reducing robustness of the first seal 68. For example, the seal zone can vary in width and path while maintaining the required sealing performance.

In the connection assembly 60, the sealing mechanism for the first seal 68 is decoupled from the retention mechanism (e.g., the weld joint 64), allowing independent optimization of each. Selecting a material for the inlet fitting 40, 140 that is harder than the fuel rail material allows for the intended rail material displacement, “filling the space” between the inlet fitting 40, 140 and the inlet 26 through a direct application of axial force without introducing frictional forces that reduce efficiency. Such frictional forces occur in some conventional fuel systems having a single- or multiple-piece threaded inlet. In such systems, the sealing interface at the fuel rail inlet may be achieved via a “sealing force” generated by converting the tightening torque into sealing force. This may be inefficient and variable due to friction present in the threaded connection. In such systems, a lubricant is often applied to the threads and interfaces to separate the parts while assembling to prevent heat buildup and friction welding and allow assembly. Such lubricant application may add labor and materials cost to the assembly.

Advantageously, the mating interface between the spherical shape of the inlet fitting curved portion 46 and the inlet conical portion 32 provides increased position tolerance by reducing sensitivity to size, shape and position of the mating features since axial (e.g., longitudinal) travel takes up these variabilities through geometry without reducing sealing robustness. In addition, the seal zone of the first seal 68 can vary in width and path while maintaining the needed sealing performance.

The modularity of the spherical shape of the inlet fitting curved portion 46 allows for the diameter of the main fuel channel 25 of the fuel rail 20 to be changed during fuel rail design, which in turn allows for raising the system pressure due to reduced surface area inside the rail. Tints, the spherical shape of the inlet fitting curve portion 46 allows for accommodation of future needs. Conversely, the reduction in inner diameter of the fuel rail 20 allows for reducing the outer diameter of the fuel rail 20 as well.

Referring to FIG. 11, a method of manufacturing the fuel delivery system 1 will now be described. The method includes providing the inlet fitting 40, 140, the inlet fitting 40, 140 as described above (step 200), as well as providing the fuel rail 20 including the fuel rail inlet 26 described above (step 202). In some embodiments, the inlet fitting 40, 140 is a cold-forged metal part, whereas in other embodiments the inlet fitting 40, 140 is formed in a precision machining process. The steps of providing the inlet fitting 40, 141 (step 200) and providing the fuel rail 20 (step 202) include selecting the material from which the inlet fitting 40, 141 and fuel rail 20 are made. In some embodiments, the inlet fitting 40, 140 is formed of a material having a hardness that is greater than the hardness of the material used to form the fuel rail inlet. As a result, when the first seal 62 is formed between the inlet fitting curved portion 46 and the inlet conical portion 32 by compressing the inlet fitting 40, 141 into the inlet 26 until deformation occurs, the surface of the inlet conical portion is deformed rather than the surface of the inlet fitting 40, 141.

Once the inlet fitting 40, 140 and the fuel rail 20 have been provided, the method includes inserting the leading end 41 of the inlet fitting 40, 140 into the inlet passageway 27 of the fuel rail inlet 26 (step 204). In some embodiments, the step of inserting continues until the curved portion 46 of the inlet fitting 40, 140 abuts the inlet conical portion 32.

The method includes applying a force to the inlet fitting (step 206) in a direction parallel to the fuel rail longitudinal axis 24 and toward the log 21. In this step, the applied force compresses the inlet fitting 40, 140 into the inlet conical portion 32, and the amount of force applied is sufficient to cause the inlet fitting 40, 140 to deform the inlet conical portion 32 so as to conform to the inlet fitting 40. As a result, the first seal 68 is formed between the inlet fitting 40, 140 and the conical portion 32 of the inlet passageway 27. In some embodiments, the inlet fitting 40, 140 is urged into a fixed fuel rail 20, whereas in other embodiments, the inlet fitting 40, 140 is held fixed while the fuel rail 20 is pulled toward the inlet fitting 40, 140. In some embodiments, the force is applied continuously until the first seal 68 is formed. In other embodiments, the method step of applying a force to the inlet fitting includes a pressing operation that employs rapid changes of at least one of the pressing distance and the rate of pressing. Such a pressing operation that employs rapid changes of the distance and rate of pressing can be employed to “hammer form” the first seal 68. This insures a matched shape between the curved portion 46 of the inlet fitting 40, 140 and the conical portion 32 of the fuel rail inlet 26 for each individual assembly 60, reducing the size and surface finish precision needed of the individual components. The inlet fitting 40, 140 can be rotated a few degrees during the “hammering” to dislodge any minute contamination.

In some embodiments, before fixing the inlet fitting 40, 140 to the fuel rail inlet 26 via the weld joint 64 as described in the next step, the method may include a step of pressurizing the fuel rail to 20 with a fluid (for example, a gas such as N2 or HE may be employed), and measuring the pressure held. This allows for a feedback system for controlling the insertion process, and permits adjustment of the applied force during each assembly.

While the inlet fitting 40, 140 and fuel rail 20 are forced together to an extent that the first seal 68 is formed, the method includes forming the weld joint 64 between the inlet fitting 40, 140 and the fuel rail inlet 26 (step 208). In other words, the applied force, or a portion thereof, is maintained until the weld joint 64 is formed and sufficiently cooled. The weld joint 64 is disposed at a location that joins inlet fitting intermediate portion 43 to a surface of the inner chamber 31. In some embodiments, the weld joint 64 is closer to the inlet outer end 30 than to the conical portion 32, and for example may he disposed between the flange 29 and the inlet outer end 30. The weld joint 64 extends about a circumference of the inlet fitting 40, 140. In some embodiments, the weld joint 64 is discontinuous along the circumference. In other embodiments, the weld joint 64 extends continuously about the circumference to form closed ring that provides the second fluid-tight seal 69 between the inlet fitting 40, 140 and the fuel rail inlet 26 (e.g., the inner surface of the inlet passageway 27). In some embodiments, the weld joint 64 is formed using a laser welding process.

The fuel supply line 4 is then connected to the inlet fitting (step 210). This is accomplished by inserting gland 12 of the pipe 10 into the entrance cavity 50, 150 of the trailing end 42 of the inlet fitting 40, 140, and engaging the internal thread 15 of the gland nut 14 with the external thread 49 of the inlet fitting 40, 140. The gland nut 14 is then sufficiently tightened relative to the inlet fitting 40, 140 so that the gland 12 abuts, and forms a third fluid-tight seal 70 with the conical surface of the entrance cavity 50, 150.

By this method, the fuel supply line 4 is reliably connected to the fuel rail inlet 26 in a fluid sealed manner.

Advantageously, the connection assembly 60 avoids some technical challenges associated with some conventional fuel systems in which connection between the fuel line and the fuel rail is achieved using filler and a brazing process. Such conventional fuel rail assemblies have many special requirements that must be met to insure reliable sealing. For example, the brazing requires a small thickness (for example, less than 150 microns) to develop sufficient strength in the joint. Often there are pre-processes such as Copper paste application, foil or solid form positioning, tack welding or affixing that must occur. In addition, brazing may require a multi chamber brazing furnace with sensitive and variable controls, and the brazing process can sometimes produce low yields requiring multiple passes through the brazing furnace, which affects all connections and elements of the fuel rail not just the inlet connection. Moreover, the brazing process may use temperatures which may anneal the materials involved and reduce their in-service strength. Still further, since the method of manufacturing a fuel supply system described herein and the connection assembly 60 is flee of brazing, the number of materials that can be used to form the fuel rail (which can be different from the material of the inlet 40) is increased and the options for configuring fuel rails of reduced weight and size are also increased.

In some embodiments, the fuel rail inlet 26 includes the radial flange 29, which is disposed close to the weld joint 64. The load applied to the inlet fitting 40, 140 during insertion goes to ground through the flange 29. The flange 29 can extend continuously about the circumference of the inlet 26, or may be discontinuous along the circumference, as required by the application. This short load path allows modular application of the inlet 26 to other rail designs as the remaining rail shape is not considered in the assembly of the inlet.

Although the fuel rail 20 is described herein as being a monolithic structure manufactured of a piece in a forging process, the fuel rail 20 is not limited to being manufactured via forging process. For example, the fuel rail structure may be manufactured as a monolithic structure via other processes, such as, but not limited to, casting or injection molding.

Although the illustrated embodiments include a fuel rail structure that supplies high pressure fuel directly to the cylinders of an engine via fuel injectors, the fuel rail structure is not limited to be used in a high pressure, direct injection fuel supply system. For example, in other embodiments, the fuel rail structure may supply fuel at relatively low pressure. In still other embodiments, the fuel rail structure may supply fuel to an accessory fuel distribution connection port or fuel dependent paths and components (such as pressure relief valves) to supply fuel to cylinders indirectly or return fuel to fuel tank.

In the illustrated embodiment, the inlet fitting 40, 140 is used to provide a sealed, reliable connection between the fuel supply line 4 and a fuel rail 20. However, it is understood that the inlet fitting 40, 140 has other applications, and can be used, for example, to provide a connection between a cross-over connection pipe (e.g., a pipe that connects two logs in a fuel injection system) and a fuel rail. In another example, the inlet fitting 40, 140 may also be employed in fluid lines used in other (e.g., non-fuel and/or non-automotive) low or high pressure applications.

Selective illustrative embodiments of the fuel delivery system, connection assembly and its method of manufacture are described above in some detail. It should be understood that only structures considered necessary for clarifying the fuel delivery system, connection assembly and its method of manufacture have been described herein. Other conventional structures, and those of ancillary and auxiliary components of the fuel delivery system, connection assembly and its method of manufacture, are assumed to be known and understood by those skilled in the art. Moreover, while working examples of the fuel delivery system, connection assembly and its method of manufacture have been described above, the fuel delivery system, connection assembly and its method of manufacture are not limited to the working examples described above, but various design alterations may be carried out without departing from the fuel delivery system, connection assembly and its method of manufacture as set forth in the claims.

1. A fitting for connecting a fluid line to an inlet of a fluid-receiving structure, the fitting comprising:
a leading end configured to be inserted into the inlet of a fluid-receiving structure, the leading end having profile in the shape of a truncated curve when the fitting is viewed in side view;
a trailing end opposed to the leading end, the trailing end being cylindrical and including an external thread that is configured to engage an internal thread of the fluid line;
an intermediate portion disposed between the leading end and the trailing end;
a fitting longitudinal axis that extends between the leading end and the trailing end; and
a fitting through passage that is co-linear with the fitting longitudinal axis and extends between the leading end and the trailing end.

2. The fitting of claim 1, wherein the fitting comprises a cavity disposed at an intersection of the through passage with the trailing end, a surface of the cavity having a conical profile when viewed in cross section.

3. The fitting of claim 1, wherein the fitting is metal and is formed in a cold forging process.

4. The fitting of claim 1, wherein the intermediate portion is cylindrical and an outer surface of the intermediate portion is free of an external thread.

5. The fitting of claim 1, wherein the external thread is shaped and dimensioned to engage with an internal thread of a gland nut of the fluid line.

6. The fitting of claim 1, wherein the fitting through passage includes a reduced diameter portion that is configured to dampen pulsation of fluid passing through the through passage.

7. A connection assembly for connecting a fluid line to an inlet of a fluid-receiving structure, the connection assembly comprising:
the inlet, the inlet including an inlet passageway that permits communication between the environment and an interior space of the fluid-receiving structure;
a fitting that includes
a leading end disposed in the inlet, the leading end having profile in the shape of a truncated curve when the fitting is viewed in side view,
a trailing end opposed to the leading end and disposed outside the inlet, the trailing end being cylindrical and including an external thread that is configured to engage an internal thread of the fluid line,
an intermediate portion disposed between the leading end and the trailing end,
a fitting longitudinal axis that extends between the leading end and the trailing end, and
a fitting through passage that is co-linear with the fitting longitudinal axis and extends between the leading end and the trailing end;
a first seal disposed between the fitting and the inlet passageway; and
a weld joint that joins the intermediate portion and the inlet passageway whereby the fitting is retained in the inlet.

8. The connection assembly of claim 7, wherein the weld joint extends about a full circumference of the inlet passageway and provides a second seal between the fitting and the inlet passageway.

9. The connection assembly of claim 7, wherein
the external thread is shaped and dimensioned to engage with an internal thread of a gland nut of the fluid line, and
the fitting through passage includes a portion that is configured to form a third seal with a spherical element of the fluid line when the gland nut is engaged with the external threads.

10. The connection assembly of claim 7, wherein
the inlet passageway comprises:
a passageway cylindrical portion that opens at an open end of the inlet, the passageway cylindrical portion having a passageway diameter that is greater than a diameter of the interior space; and
a passageway conical portion that extends between the passageway cylindrical portion and the interior space, and
a curved portion of the fitting leading end abuts the passageway conical portion in such a way that the first seal is provided between the curved portion and the passageway conical portion.

11. The connection assembly of claim 10, wherein the weld joint is disposed between the passageway conical portion and the open end of the inlet.

12. The connection assembly of claim 7, wherein the inlet comprises:
an inlet longitudinal axis that extends in parallel to the inlet passageway; and
a flange that protrudes from an outer surface of the inlet in a radial direction relative to the inlet longitudinal axis.

13. The connection assembly of claim 7, wherein the inlet is formed of a first material, the fitting is formed of a second material, and the hardness of the second material is greater than the hardness of the first material.

14. The connection assembly of claim 7, wherein the first seal is a metal-to-metal seal in which the fitting deforms a surface of the inlet passageway.

15. The connection assembly of claim 7, wherein
a curved portion of the fitting leading end abuts the passageway conical portion under a longitudinal applied force in such a way that at least one of the curved portion and the passageway conical portion is deformed, whereby the first seal is provided between the curved portion and the passageway, and
the weld joint retains the fitting and passageway under the applied force.

16. A method of manufacturing a fuel supply system that includes a fuel supply line, a fuel rail and a fitting that connects the fuel supply line to an inlet of the fuel rail, the method comprising the following method steps:
providing the fuel rail, the fuel rail comprising:
a rail log that defines an interior space, and
the inlet, the inlet comprising an inlet passageway having a conical portion, the inlet passageway communicating with the interior space,
providing the fitting, where the fitting includes a leading end configured to be received in the inlet passageway, a trailing end configured to reside outside the inlet and connect to the fuel supply line, a longitudinal axis that extends between the leading end and the trailing end, and a fitting through passage that is co-linear with the longitudinal axis and extends between the leading end and the trailing end,
inserting the leading end of the fitting into the inlet passageway,
applying a force to the fitting in a direction parallel to the longitudinal axis and toward the interior space of the log, where the force is sufficient to cause the fitting to deform a surface of the inlet passageway and form a first seal between the fitting and the surface of the inlet passageway,
forming a weld joint between the inlet and the fitting in such a way that the first seal is maintained.

17. The method of claim 16, comprising the following method steps:
providing the fuel supply line, the fuel supply line comprising
a gland nut having an internal thread,
a pipe that extends through the gland nut; and
a spherical gland disposed on a terminal end of the pipe, and
securing the fuel supply line to the fitting trailing end by engaging the internal thread with an external thread of the fitting trailing end.

18. The method of claim 16, wherein the weld joint extends about a full circumference of the fitting and provides a second seal between the fitting and the inlet.

19. The method of claim 16, wherein the fitting is manufactured using a forging process.

20. The method of claim 16, wherein the inlet is formed of a first material, the fitting is formed of a second material, and the hardness of the second material is greater than the hardness of the first material.

21. The fitting of claim 1, wherein the fitting comprises an exit cavity disposed at an intersection of the through passage with the leading end, a surface of the exit cavity having a conical profile when viewed in cross section, the exit cavity having a longitudinal dimension that is at least half the overall longitudinal dimension of the fitting.

22. The fitting of claim 1, wherein the fitting comprises:
a conical entrance cavity disposed at an intersection of the through passage with the trailing end;
an exit cavity disposed at an intersection of the through passage with the leading end, and
an intermediate cavity disposed between the entrance cavity and the exit cavity, the exit cavity having a cylindrical profile and having an exit cavity diameter that is smaller than a diameter of the intermediate cavity and smaller than a longitudinal dimension of the exit cavity.

23. The connection assembly of claim 7, wherein the weld joint is discontinuous along a circumference of the fitting.

24. The method of claim 16, wherein the weld joint is discontinuous along a circumference of the fitting.
